(19) United States
(12) Patent Application Publication
(10) Pub. No.: US 2025/0315847 A1
(43) Pub. Date: Oct. 9, 2025

(54) METHOD FOR TRAINING A COARSE RANKING SCORING MODEL FOR E-COMMERCE COMMODITIES AND RELATED PRODUCTS

(71) Applicants: Guangzhou Xiyin International Import and Export Co., Ltd., Guangdong (CN); Shenzhen Xiyin Information Technology Co., Ltd., Guangdong (CN); Nanjing Xiyin Ecommerce Co., Ltd., Jiangsu (CN)

(72) Inventors: WENKANG WEI, Guangdong (CN); YOULEI ZHANG, Guangdong (CN); BIN LUO, Guangdong (CN); WEIZHAO GUO, Guangdong (CN); XINGGUO MA, Guangdong (CN)

(21) Appl. No.: 18/809,599

(22) Filed: Aug. 20, 2024

(30) Foreign Application Priority Data
Apr. 9, 2024 (CN) 202410425132.2

(51) Int. Cl. G06Q 30/0201; G06Q 10/04

(52) U.S. Cl. CPC G06Q 30/0201; G06Q 10/04

(57) ABSTRACT

A method for training a coarse ranking scoring model includes generating training samples based on a list of commodities recommended by an e-commerce platform, using a multi-target scoring module, based on the training samples, to perform scoring operations for ranking the commodities under multiple target tasks to obtain multi-target scoring results, using a coarse ranking distillation module, based on the training samples, to perform distillation learning from a fine ranking model's scoring knowledge on fine ranking of commodities, and calculate a min-max distillation loss, and optimizing a final coarse ranking result of the coarse ranking scoring model for coarse ranking the commodities according to the multi-target scoring results and the min-max distillation loss, to train the coarse ranking scoring model for e-commerce commodities.

### CROSS-REFERENCE TO RELATED APPLICATION AND CLAIM OF PRIORITY

This application claims the benefit under 35 USC § 119 of Chinese Patent Application No. 202410425132.2, filed on Apr. 9, 2024, in the China Intellectual Property Office, the entire disclosure of which is incorporated herein by reference for all purposes.

### BACKGROUND

### 1. Technical Field

The present disclosure relates generally to the field of recommendation systems. More specifically, the present disclosure relates to a method, device, and non-transitory machine readable medium for training a coarse ranking scoring model for e-commerce commodities.

### 2. Background Art

Under the trend of rapid development of global e-commerce, e-commerce platforms have deeply penetrated into people's lives, affecting user's shopping habits and meeting their needs for personalized shopping experiences. With the development and expansion of e-commerce platforms, the number of commodities available for users to purchase through the e-commerce platforms has been increasing dramatically. In order to search and recommend commodities that meet user's personalized shopping requirements among massive commodities, a recommendation system in an e-commerce platform is of vital importance. Currently, with the support of mature artificial intelligence technology, recommendation systems have also become relatively sophisticated. They are mainly divided into a recall stage and a ranking stage according to the recommendation process. From the massive commodities, a batch of commodities which are possibly interested by a user are firstly recalled through the recall stage so as to narrow down a recommended commodity set, and then the commodities are finely ranked in the ranking stage and the commodities which are most interested by the user are displayed to the user.

Due to the fact that the recall stage generally returns thousands of commodities, if these commodities are directly entered into the ranking stage for fine ranking, it would consume a huge amount of computing resources. Therefore, the ranking stage is subdivided into a coarse ranking stage and a fine ranking stage. In the coarse ranking stage, a personalized model is responsible for quickly ranking recalled commodities under the requirement of less time consumption, then the top n commodities from the ranking sequence are input into the fine ranking stage, while the fine ranking stage spends more time to more personally and finely rank the commodities before pushing them to the user. Obviously, the personalized ranking effect of the coarse ranking is generally worse than that of the fine ranking. An existing method involves the coarse ranking stage learning from the ranking result of the fine ranking stage, a learning process known as cascade learning. This process also leverages the ideas of distillation learning or transfer learning to transfer (or distill) the knowledge of the fine ranking into the coarse ranking. However, the existing idea of distillation learning cannot adequately learn the sequential order of the entire score ranking sequence, thus affecting the ranking learning effect, and calculation of a loss function is relatively complex. In addition, the existing method takes the distillation loss as an auxiliary loss, which cannot well adjust the effect of the knowledge transferred from the fine ranking model (i.e., the teacher model) on the final output scores of the coarse ranking model (i.e., the student model) when involving a multi-target business task.

In view of the above, it is desirable to provide a solution for training a coarse ranking scoring model for e-commerce commodities, in order to efficiently calculate a loss function, reduce computational complexity of the loss function, enable the coarse ranking model to better learn the knowledge of a fine ranking model, and easily transfer the learned target capability of the fine ranking model to the coarse ranking model without affecting the existing coarse ranking knowledge, even under a multi-target business task.

### SUMMARY

To address at least one or more of the above-mentioned technical problems, the present disclosure proposes a scheme for training a coarse ranking scoring model for e-commerce commodities in multiple aspects.

In a first aspect, embodiments of the present disclosure provide a method for training a coarse ranking scoring model for e-commerce commodities, wherein the coarse ranking scoring model comprises a multi-target scoring module and a coarse ranking distillation module, and the method comprises: generating training samples based on a list of commodities recommended by an e-commerce platform in response to a user request; using the multi-target scoring module, based on the training samples, to perform scoring operations for ranking the commodities under multiple target tasks so as to obtain multi-target scoring results; using the coarse ranking distillation module, based on the training samples, to perform distillation learning from a fine ranking model's scoring knowledge on fine ranking of commodities, and calculate a min-max distillation loss; and optimizing a final coarse ranking result of the coarse ranking scoring model for coarse ranking the commodities according to the multi-target scoring results and the min-max distillation loss, to train the coarse ranking scoring model for e-commerce commodities.

In a second aspect, embodiments of the present disclosure provide a device for training a coarse ranking scoring model for e-commerce commodities, comprising: a processor; and a memory having stored thereon computer instructions for training a coarse ranking scoring model for e-commerce commodities that, when executed by the processor, cause implementation of embodiments in the aforementioned first aspect.

In a third aspect, embodiments of the present disclosure provide a non-transitory machine readable medium having stored thereon computer program instructions for training a coarse ranking scoring model for e-commerce commodities, which when executed by one or more processors, cause implementing embodiments in the aforementioned first aspect.

According to the above scheme for training a coarse ranking scoring model for e-commerce commodities, embodiments of the present disclosure improve the consistency between the coarse ranking scoring and fine ranking scoring through a simple min-max distillation loss during distillation learning of the fine ranking model's scoring knowledge on fine ranking of commodities in the coarse ranking distillation module. This enables efficient calculation of the loss function, reduces the computational complexity of the loss function, and allows the coarse ranking model to better fit the fine ranking result, improving the scoring accuracy of the coarse ranking model. Further, in some embodiments of the present application, the final coarse ranking result of the coarse ranking scoring model for coarse ranking the commodity may be optimized by distilling fine ranking knowledge into a separate model target tower (i.e., the coarse ranking distillation module) and combining it with the multi-target scoring results. Based on this, even under a multi-target business task, the target capabilities learned from the fine ranking can be easily transferred to the coarse ranking model without affecting the existing coarse ranking knowledge, making the level of knowledge transferred from the fine ranking model controllable.

### BRIEF DESCRIPTION OF THE DRAWINGS

By referring to the accompanying drawings for a detailed description of the exemplary embodiments of the present disclosure, the aforementioned and other objectives, features, and advantages of the exemplary embodiments will become easier to understand. In the drawings, several embodiments of the present discourse are shown in an exemplary and non-limiting manner, and the same or corresponding reference numerals indicate the same or corresponding parts, where:

FIG. 1 is an exemplary flowchart illustrating a method for training a coarse ranking scoring model for e-commerce commodities according to an embodiment of the present disclosure;

FIG. 2 is an exemplary flowchart illustrating generation of training samples according to an embodiment of the present disclosure;

FIG. 3 is an overall exemplary flowchart illustrating generation of training samples according to an embodiment of the present disclosure;

FIG. 4 is an exemplary flowchart illustrating calculation of a min-max distillation loss according to an embodiment of the present disclosure;

FIG. 5 is an exemplary schematic diagram illustrating calculation of a min-max distillation loss according to an embodiment of the present disclosure;

FIG. 6 is an exemplary schematic diagram illustrating the overall coarse ranking scoring model according to an embodiment of the present disclosure;

FIG. 7 is an exemplary flowchart illustrating a method for coarse ranking scoring of e-commerce commodities according to an embodiment of the present disclosure; and

FIG. 8 is an exemplary structural diagram of a device for training a coarse ranking scoring model for e-commerce commodities according to an embodiment of the present disclosure.

### DETAILED DESCRIPTION

Technical solutions in embodiments of the present disclosure will be described clearly and completely hereinafter with reference to the drawings in the embodiments of the present disclosure. Obviously, the embodiments to be described are merely some, rather than all, embodiments of the present disclosure. All other embodiments obtained by those skilled in the art based on the embodiments of the present disclosure without creative efforts shall fall within the scope of protection of the present disclosure.

It should be understood that terms “including” and “comprising” used in the specification and the claims indicate the presence of a feature, entity, step, operation, element, and/or component, but do not exclude the existence or addition of one or more of other features, entities, steps, operations, elements, components, and/or collections thereof.

It should also be understood that the terms used in the specification of the present disclosure are merely intended to describe specific embodiments rather than to limit the present disclosure. As used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of the relevant listed items and includes these combinations.

As used in the specification and the claims of the present disclosure, a term “if” may be interpreted as “when”, or “once” or “in response to a determination” or “in response to a case where something is detected” depending on the context. Similarly, the phrase “if it is determined” or “if a [described condition or event] is detected” may be interpreted as “once determining” or “in response to determining” or “once detecting [the described condition or event]” or “in response to detecting [the described condition or event]” depending on the context.

As described in the background above, the ranking stage includes a coarse ranking stage and a fine ranking stage. A personalized model in the coarse ranking stage is responsible for quickly ranking recalled commodities with the requirement of less time consumption. Then, the top n commodities from the ranking sequence are input into the fine ranking stage, while the fine ranking stage spends more time to more personally and finely rank the commodities before pushing them to the user. Therefore, the personalized ranking effect of the coarse ranking is generally worse than that of the fine ranking. It is understood that the methods allowing a model to learn better ranking are collectively referred to as Learning To Rank (“LTR”), and typical methods for LTR include single-document (“Point-Wise”), pairs of documents (“Pair-Wise”), and lists of documents (“List-Wise”). The aforementioned cascade learning can also be subdivided into Point-Wise, Pair-Wise and List-Wise types, but there is few research for List-Wise cascade learning, and the calculation methods for List-Wise cascade learning are relatively complex.

In deep learning, the idea of distillation learning is to make a student model's output ranking scores or the model's intermediate output embedding vectors to try to learn and approach a teacher model's ranking scores or intermediate output embedding vectors. In cascade learning, the coarse ranking model corresponds to the student model, while the fine ranking model corresponds to the teacher model. The loss function used in this learning process is typically Point-Wise loss function. However, in the Point-Wise learning method, the coarse ranking model does not learn the relationship of the sequential order among multiple commodities scores in the fine ranking model. In the field of recommendation algorithms, attempts have been made to use the Pair-Wise Loss method to let the coarse ranking model learn the sequential order of commodity scores in the fine ranking model. For example, when a fine ranking request returns a list, one item is randomly sampled from the top n items with high fine ranking scores at the head of the list, and then one item is sampled from the tail of the list, forming a pair of samples to let the model learn to separate and increase the distance between these two samples. Therefore, the method can only learn the sequential relationship between each sampled pair of samples, and cannot learn the anterior-posterior relationship between all commodities scores in the entire fine ranking list.

By extending the above problem to the List-Wise Loss learning method, which often adopts RankNet, LambdaMART, etc., this kind of List-Wise method always needs to first convert the ranking into pairs through sampling, and then traverse each pair individually to compare the scores before calculating the Loss. This method requires comparing the fine ranking scores of any two commodities within a ranking, which makes the calculation overly complex.

In addition, in most cascade learning algorithms, the distillation learning method often takes the distillation loss as an auxiliary loss to train the model's final output. This approach does not effectively control the impact of knowledge distilled from the teacher model to the student model on the student model's final output, especially in the recommendation field where multiple business objectives (e.g., click-through rate, add-to-cart rate, and conversion rate, etc.) are optimized simultaneously. In such scenarios, if the fine ranking model (i.e., the teacher model) is a conversion rate model and the coarse ranking model (i.e., the student model) is a click-through rate model, then using distillation learning to let the coarse ranking model learn the fine ranking model's ranking will lead to the coarse ranking optimization goal shifting from improving click-through rate to improving both click-through rate and conversion rate. This method makes it difficult to control whether the final coarse ranking should optimize the click-through rate effect or the conversion rate effect.

Based on this, the present disclosure proposes a scheme for training a coarse ranking scoring model for e-commerce commodities. By calculating a simple min-max distillation loss, consistency between the coarse ranking scoring and the fine ranking scoring is improved, allowing the coarse ranking model to better fit the fine ranking result, and enhancing the scoring accuracy of the coarse ranking model. Further, by distilling fine ranking knowledge into a separate model target tower and combining it with the multi-target scoring results to optimize the coarse ranking scoring model, the degree of knowledge transferred from the fine ranking model is controllable.

Specific implementations of the present disclosure will be described in detail in combination with drawings below.

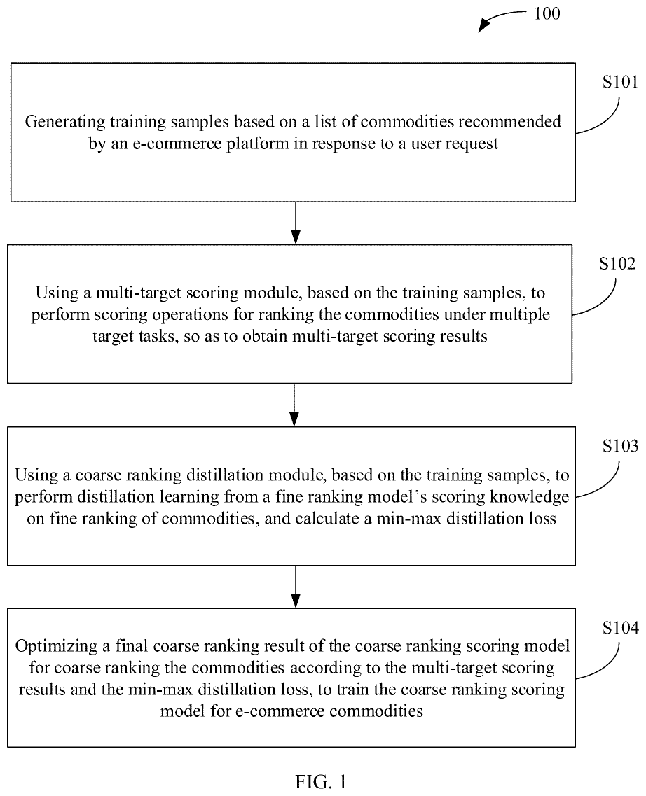

FIG. 1 is an exemplary flowchart illustrating a method 100 for training a coarse ranking scoring model for e-commerce commodities according to an embodiment of the present disclosure. In one implementation scenario, the coarse ranking scoring model may include a multi-target scoring module and a coarse ranking distillation module. The multi-target scoring module may include a Multi-Layer Perceptron (“MLP”), a click-through rate tower module, and a conversion rate tower module. In some embodiments, the MLP, click-through rate tower module, and conversion rate tower module within the multi-target scoring module may have been loaded with trained weight parameters. That is, the multi-target scoring module has already been trained. When training the coarse ranking scoring model, it is only necessary to optimize the coarse ranking distillation module to control the degree of knowledge transferred from the fine ranking model.

As shown in FIG. 1, at step S101, training samples are generated based on a list of commodities recommended by an e-commerce platform in response to a user request. In one embodiment, firstly, it is determined whether the list of commodities recommended by the e-commerce platform in response to a user request contains commodities under a target task. Then, based on the determination result of whether the list of commodities recommended by the e-commerce platform in response to a user request contains commodities under a target task, a training dataset is constructed to generate training samples. In some implementation scenarios, the aforementioned target task may include, but is not limited to, a click operation, a conversion operation, and the like, and the aforementioned conversion operation may include, but is not limited to, an add-to-cart operation and/or a place-order operation.

As an example, let trace_id be a request ID that identifies the list of commodities recommended in one time during a user's browsing session on the e-commerce platform APP, with the j-th request named Gⱼ. Then, let the sample index in the j-th request Gⱼ be i, and a sample in the j-th request Gⱼ with a click operation, an add-to-cart operation, or a place-order operation is named as Pⱼᵢ. That is, when generating training samples, it is first determined whether a sample Pⱼᵢ exists in a commodity list returned in response to a user request, and then a training dataset is constructed based on this determination to generate training samples. In one embodiment, first sample data and second sample data can be constructed based on the determination result of whether the list of commodities recommended by the e-commerce platform in response to a user request contains commodities under a target task, and then a training dataset is constructed based on the first sample data and the second sample data to generate training samples. That is, the first sample data and the second sample data are constructed based on the determination of whether a sample Pⱼᵢ exists in the commodity list returned in response to the user request, and then the first sample data and the second sample data in all requests are put into a training dataset “listwise” as training samples.

In an implementation scenario, in response to the existence of a commodity under the target task in the commodity list recommended by the e-commerce platform returned in response to the user request, the commodity fine ranking scores and commodity features of the other commodities except the commodity under the current target task are aggregated into multiple first list features, and the first list features are added to the commodity under the current target task to form first sample data. Conversely, in response to the absence of a commodity under the target task in the commodity list recommended by the e-commerce platform returned in response to the user request, the commodity fine ranking scores and commodity features of the commodities except the commodity with the highest fine ranking score are aggregated into multiple second list features, and the second list features are added to the commodity with the highest fine ranking score to form second sample data. Among them, the other commodities except the commodity under the current target task contain the commodities corresponding to the label values as less than the label value of the commodity under the current target task.

Specifically, for the case where the commodity list returned in response to a user request contains a sample Pⱼᵢ, the fine ranking scores and commodity features of the other samples except the sample Pⱼᵢ are aggregated into multiple first list features “list1”, and the first list features list1 are added into the sample Pⱼᵢ to form the first sample data. For the case where the commodity list returned in response to a user request does not contain a sample Pⱼᵢ, that is, there are only exposed samples without click/add-to-cart/place-order operation operations, denote them as Nⱼᵢ. In this case, an exposed sample Sⱼ with the highest fine ranking score is determined from the samples Nⱼᵢ, the fine ranking scores and the commodity features of the samples except the samples Sⱼ are aggregated into multiple second list features “list2”, and the second list features list2 are added into the samples Sⱼ to form the second sample data. Further, the first sample data and the second sample data are placed into the training dataset “listwise” to generate training samples.

In some embodiments, assuming that the label for only exposed sample is 0, the label for clicked sample is 1, the label for added-to-cart sample is 2, and the label for placed-order sample is 3, the above step of generating the training set can also be understood as aggregating the commodities IDs and online fine ranking scores of all samples [s₁, s₂, . . . , sₘ] whose label values as less than the label value of the current sample sₖ in the request Gⱼ into a commodity list [goods₁, goods₂, . . . , goodsₘ], respectively, and adding the commodity list [goods₁, goods₂, . . . , goodsₘ] and the fine ranking score list [score₁, score₂, . . . , scoreₘ] as new sequence features into the sample sₖ to form the list features, and then combining the list features corresponding to each request into training samples. If there are no samples with the label values larger than 0 in the request Gⱼ, the sequence features of the commodity list and the fine ranking score list are added to the sample Sⱼ, and only the exposed sample Sⱼ with the highest fine ranking score is returned by the current request Gⱼ. Based on this, by using the samples with the highest fine ranking scores in the requests as positive samples for cascading training, the utilization rate of the exposed samples and the effectiveness of cascade learning are improved.

Based on the training samples generated as described above, at step S102, a multi-target scoring module is used to perform scoring operations for ranking the commodities under multiple target tasks, so as to obtain multi-target scoring results. Specifically, in one embodiment, a Multi-Layer Perceptron (MLP) is used for feature extraction from the training samples, a Click-Through Rate (CTR) tower module and a conversion rate tower module are used for scoring operations for ranking commodities under click and conversion operations, respectively, to obtain a click-through rate scoring result and a conversion rate scoring result. That is to say, the training samples are input into the multi-target scoring module, where feature extraction is first performed by the MLP within the multi-target scoring module, followed by the output of corresponding click-through rate and conversion rate scoring results through the CTR tower module and conversion rate module, respectively. The click-through rate is related to the click operation, and the conversion rate is related to the add-to-cart operation or the place-order operation. From the foregoing, it is known that the MLP, CTR tower module, and conversion tower module in the multi-target scoring module have been loaded with trained weight parameters, i.e., loaded with baseline model knowledge using an incremental learning method.

Next, at step S103, based on the training samples, the coarse ranking distillation module is used to perform distillation learning from a fine ranking model's scoring knowledge on fine ranking of commodities, and calculate a min-max distillation loss. In an implementation scenario, the training samples are first subject to feature extraction by the MLP, followed by distillation learning through the coarse ranking distillation module on the fine ranking model's knowledge of commodity fine ranking, and calculation of the min-max distillation loss. Specifically, in one embodiment, fine ranking scores of the fine ranking model for commodity fine ranking under the training samples are obtained, coarse ranking scores for commodity fine ranking under the training samples are output by the coarse ranking distillation module, and the coarse ranking scores are normalized to obtain normalized coarse ranking scores. The min-max distillation loss is then calculated based on the fine ranking scores and the normalized coarse ranking scores. Namely, the fine ranking scores and the coarse ranking scores are obtained through the fine ranking model and the coarse ranking distillation module respectively, and then the min-max distillation loss is calculated based on the normalized coarse ranking scores and the fine ranking scores.

More specifically, in one embodiment, a maximum fine ranking score and a minimum fine ranking score are determined from the fine ranking scores, and the commodity indices corresponding to the maximum fine ranking score and the minimum fine ranking score are identified. The normalized coarse ranking scores of the commodities with the maximum and minimum fine ranking scores are then determined based on their respective commodity indices. The min-max distillation loss is subsequently calculated based on the normalized coarse ranking score of the commodity with the maximum fine ranking score and the normalized coarse ranking score of the commodity with the minimum fine ranking score. In one implementation scenario, the min-max distillation loss is calculated using the negative logarithm of the normalized coarse ranking score of the commodity with the maximum fine ranking score and the normalized coarse ranking score of the commodity with the minimum fine ranking score. That is, in these embodiments of the present disclosure, the distillation learning process is improved by identifying commodities corresponding to the minimum and maximum fine ranking scores, finding their respective normalized coarse ranking scores, and then calculating the min-max distillation loss using the negative logarithm of the normalized coarse ranking score of the commodity with the maximum fine ranking score and the normalized coarse ranking score of the commodity with the minimum fine ranking score.

In an exemplary scenario, assume that the size of a batch of training samples is B, and for the i-th sample within the batch, its exposed commodity ID sequence feature is gᵢ, and a fine ranking score sequence corresponding to the exposed commodity ID sequence is zᵢ. Here, both gᵢ and zᵢ have a feature length of N, which indicates N exposed commodities and their corresponding N fine ranking scores. Assume that the coarse ranking model's predicted coarse ranking scores for the exposed commodity list of the i-th sample are yᵢ, the length of which is also N. In this scenario, let k=argmax(zᵢ) denote the index of the commodity with the highest fine ranking score in the fine ranking of the i-th sample (i.e., the index of the exposed commodity with the highest fine ranking score), and let j=argmin(zᵢ) denote the index of the exposed commodity with the lowest fine ranking score in the fine ranking. Thus, the aforementioned min-maximum distillation loss can be represented by the following formula:

$$Loss = \frac{1}{B} {\sum }_{i}^{B} ( soft {max ( {y}_{i} )}_{j} - log ( soft {max ( {y}_{i} )}_{k} ) ) \qquad ( 1 )$$

Here, Loss represents the min-max distillation Loss, softmax(yᵢ)ⱼ represents a normalized coarse ranking score of the commodity j with the minimum fine ranking score, and softmax(yᵢ)ₖ represents a normalized coarse ranking score of the commodity k with the maximum fine ranking score. The Softmax normalization of the coarse ranking scores represents a probability that the corresponding commodity in the predicted commodity list will be ranked at the top of the recommendation list by the fine ranking model, and −log denotes the negative logarithm.

It will be appreciated that the min-max distillation loss in the embodiments of the present disclosure is equivalent to maximizing the predicted coarse ranking score of the commodity with the maximum fine ranking score returned by a single fine ranking request or minimizing the negative logarithmic form of the predicted coarse ranking score of the commodity with the maximum fine ranking score, and minimizing the predicted coarse ranking score of the commodity with the minimum fine ranking score. Based on the min-max distillation loss, it is possible to widen the gap between the predicted coarse ranking scores of the commodity with the maximum fine ranking score, the commodity with the minimum fine ranking score, and other commodities. With the scheme of the present disclosure, the computational complexity of the min-max distillation loss for a single sample is O(N), where N is the length of the score sequence for a List-Wise sample.

Compared to existing methods (e.g., LambdaMART, RankNet, etc.), in the embodiments of the present disclosure, there is no need of sampling of samples for the min-max distillation loss, making the calculation simpler. In addition, in the embodiments of the present disclosure, the min-max distillation loss is only related to the ordering of the fine ranking scores, not their magnitudes. This avoids the problem in recommendation systems where due to severely imbalanced sample categories, model scores approach 0, the distance between different commodities' fine ranking scores and the loss also approach 0, causing the model to fail to learn the knowledge of the ordering of different commodity scores within a same list. It improves the consistency between coarse ranking scoring and fine ranking scoring, enabling the coarse ranking model to better fit the fine ranking results and enhance the scoring accuracy of the coarse ranking model.

Further, at step S104, according to the multi-target scoring results and the min-max distillation loss, a final coarse ranking result of the coarse ranking scoring model for coarse ranking the commodities is optimized to train the coarse ranking scoring model for e-commerce commodities. In one implementation scenario, weighting coefficients are respectively set for the click-through rate scoring result, the conversion rate scoring result and the predicted coarse ranking result output from the coarse ranking distillation module and adjusted based on the min-max distillation loss. Then, these corresponding weighting coefficients are adjusted to optimize the final coarse ranking results of the coarse ranking scoring model, thereby training the coarse ranking scoring model for e-commerce commodities.

For example, let's assume that the click-through rate scoring result is denoted as o₁, the conversion rate scoring result is denoted as o₂, the predicted coarse ranking result output from the coarse ranking distillation module and adjusted based on the min-max distillation loss is denoted as o₃, with their respective weighting coefficients denoted as w₁, w₂, and w₃. In one implementation scenario, the final coarse ranking result of the coarse ranking scoring model for commodity coarse ranking can be obtained based on w₁*o₁+w₂*o₂+w₃*o₃. During the training process, only the coarse ranking distillation module may be fine-tuned by using the min-max distillation loss described above to distill fine ranking knowledge into the coarse ranking distillation module, while the click-through rate tower module and the conversion rate tower module remain unchanged. Furthermore, by adjusting the aforementioned weighting coefficients w₁, w₂, and w₃, the influence of the coarse ranking distillation module's output on the final scoring of the coarse ranking scoring model is determined, thus adjusting the impact of fine ranking model's knowledge on the coarse ranking output.

In some embodiments, if the fine ranking model is a conversion rate model, the final scoring of the coarse ranking scoring model trained according to embodiments of the present disclosure can better improve the conversion rate. If the fine ranking model is a click-through rate model, the final scoring of the coarse ranking scoring model trained according to embodiments of the present disclosure can more effectively enhance the click-through rate. Therefore, it is possible to easily transfer the target capabilities learned from the fine ranking into the coarse ranking model, enhancing the accuracy of the coarse ranking scoring model without affecting the existing coarse ranking knowledge.

From the above description, it is evident that, in the embodiments of the present disclosure, a loss can be calculated quickly through a simple min-max distillation loss calculated during the distillation learning of the fine ranking model's knowledge on fine ranking of commodities in the coarse ranking distillation module, without needing to traverse each pair-wise sample, thereby reducing the computational complexity. The min-max distillation loss calculated in the embodiments of the present disclosure can avoid the problem where the coarse ranking model learns little due to the extremely small fine ranking scores of the fine ranking model in the recommendation system caused by severely imbalanced samples. It also avoids the problem where the difference in scores between different commodities within a same List-Wise sample becomes very small when the fine ranking scores are too low, which is not conducive to the coarse ranking model learning the knowledge on the order and difference in scores between different commodities. This enables the coarse ranking model to better fit the fine ranking results, thereby enhancing the accuracy of the coarse ranking scoring model.

Furthermore, in some embodiments of the present disclosure, by utilizing incremental learning and multi-target modeling (such as the aforementioned multi-target scoring module), and introducing a coarse ranking distillation module dedicated for distillation learning along with corresponding weighting coefficients so as to only fine-tune the coarse ranking distillation module based on the min-max distillation loss, it can be easy to integrate the knowledge of the fine ranking model into the coarse ranking model without significantly affecting the existing knowledge of the coarse ranking, making the level of knowledge transferred from the fine ranking model controllable. Additionally, in some embodiments of the present disclosure, by including commodity samples with the highest fine ranking scores into the training samples, the utilization rate of exposed samples and the effectiveness of cascading learning are improved.

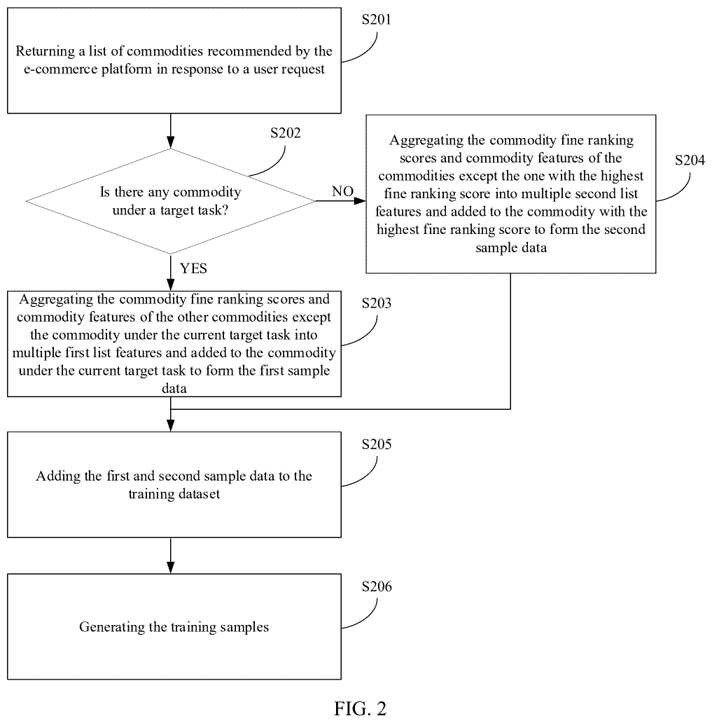

FIG. 2 is an exemplary flowchart illustrating the generation of training samples according to an embodiment of the present disclosure. It can be understood that FIG. 2 is merely an embodiment of step S101 described in the context of FIG. 1, and thus the description provided for FIG. 1 can also apply to FIG. 2.

As shown in FIG. 2, at step S201, a list of commodities recommended by the e-commerce platform is returned in response to a user request, i.e., obtaining the original samples. Then, at step S202, it is determined whether the list of commodities recommended and returned by the e-commerce platform in response to a user request contains commodities under a target task. As previously mentioned, the target task could be operations such as a click operation, an add-to-cart operation or a place-order operation. Based on the determination of whether the list of commodities contains commodities under a target task, a training dataset can be constructed to generate training samples.

Specifically, if there are commodities under the target task in the list of commodities recommended and returned by the e-commerce platform in response to the user request, at step S203, the commodity fine ranking scores and commodity features of the other commodities except those commodities under the current target task are aggregated into multiple first list features and added to the commodity under the current target task to form the first sample data. For example, taking add-to-cart as the target task, if there are commodities in the commodity list that were added to the cart, the fine ranking scores and commodity features of samples (e.g., samples with operations like clicks) except samples with an add-to-cart operation can be aggregated into multiple list features and added to the add-to-cart commodity to form the first sample data.

If there are no commodities under the target task in the commodity list recommended and returned by the e-commerce platform in response to the user request, at step S204, the commodity fine ranking scores and commodity features of the commodities except the one with the highest fine ranking score are aggregated into multiple second list features and added to the commodity with the highest fine ranking score to form the second sample data. It is understood that when there are no commodities under the target task (such as click-through, add-to-cart, place-order) in the commodity list, meaning only exposed commodities exist. In this case, the fine ranking scores and features of samples except the one with the highest fine ranking score are aggregated into multiple second list features and added to the sample with the highest fine ranking score to form the second sample data.

Further, at step S205, the first and second sample data are added to the training dataset, leading to the generation of training samples at step S206. By incorporating the samples with the highest fine ranking scores returned in response to the requests into the training dataset as positive samples for cascading learning, the utilization rate of exposed samples and the effectiveness of cascading learning are improved.

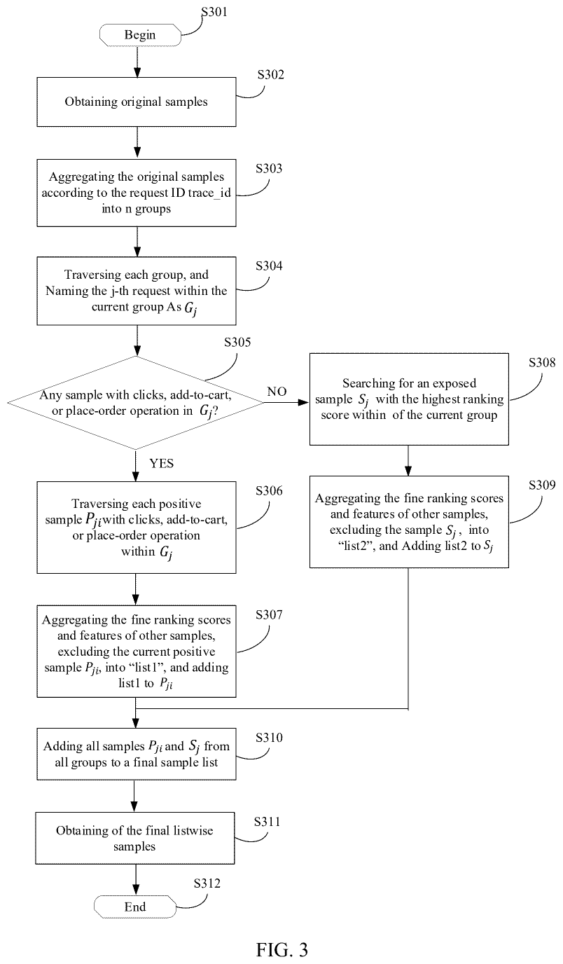

FIG. 3 is an overall exemplary flowchart for generating training samples according to an embodiment of the present disclosure. As shown in FIG. 3, the process of generating training samples begins at step S301. In generating training samples, firstly at step S302, a list of commodities is returned according to user requests, i.e., obtaining original samples. Then, at step S303, according to the request ID trace_id, the aforementioned original samples are aggregated into n groups. Here, trace_id is identified as the request ID for a list of commodities recommended in one time during a user's browsing session on the e-commerce platform APP. At step S304, each group is traversed, and the j-th request within the current group is named Gⱼ.

Based on Gⱼ in the current group, at step S305, it is determined whether Gⱼ contains samples with clicks, add-to-cart, or place-order operations. When Gⱼ in the current group contains samples with clicks, add-to-cart, or place-order operations, at step S306, each positive sample with clicks, add-to-cart, or place-order operations within Gⱼ of the current group is traversed, denoted as Pⱼᵢ, where i represents the sample index in the j-th request Gⱼ. At step S307, the fine ranking scores and commodity features of other samples, excluding the current positive sample Pⱼᵢ, are aggregated into multiple first list features “list1”, and these multiple first list features list1 are added to the positive sample Pⱼᵢ to form the first sample data in the context of the present disclosure.

When Gⱼ in the current group does not contain samples with clicks, add-to-cart, or place-order operations, meaning there are only exposed samples, at step S308, an exposed sample with the highest ranking score within Gⱼ of the current group is searched for, which is denoted as Sⱼ. Then, at step S309, the fine ranking scores and commodity features of other samples, excluding the sample Sⱼ, are aggregated into multiple second list features “list2”, and these multiple second list features list2 are added to the sample Sⱼ to form the second sample data.

After forming the aforementioned first and second sample data, at step S310, all samples Sⱼ and Pⱼᵢ from all groups are added to a final sample list (i.e., the training dataset), leading to the obtaining of the final listwise samples at step S311 to generate training samples. Finally, the process of generating training samples concludes at step S312.

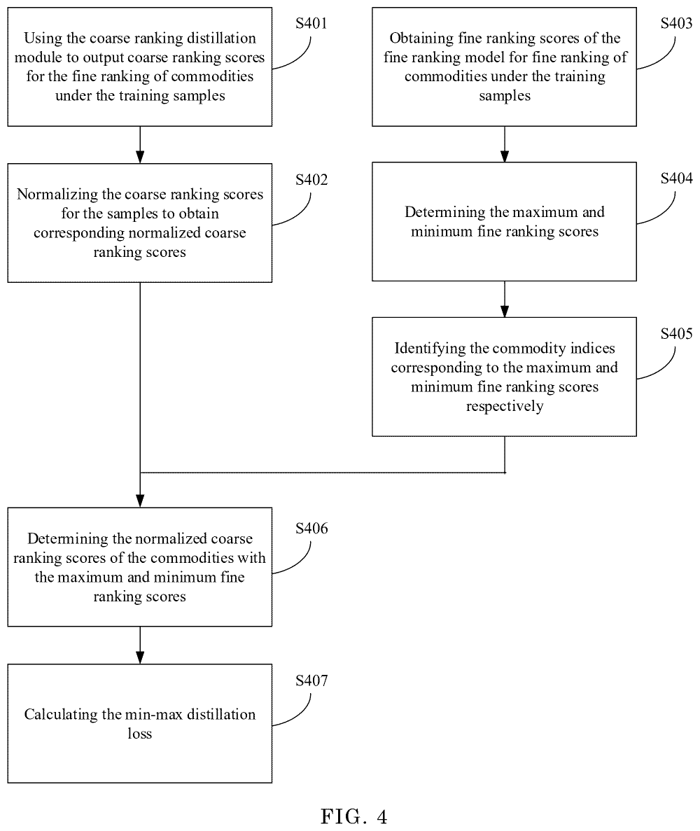

In the embodiments of the present disclosure, based on the training samples generated as described, the multi-target scoring module can be used to perform scoring operations for ranking commodities under target tasks to obtain multi-target scoring results. Furthermore, the coarse ranking distillation module can perform distillation learning of the fine ranking model's knowledge on fine ranking of commodities and calculate the min-max distillation loss, thereby optimizing the final coarse ranking results of the coarse ranking scoring model for commodities. Next, the calculation of the min-max distillation loss is described in conjunction with FIG. 4.

FIG. 4 is an exemplary flowchart illustrating the calculation of the min-max distillation loss according to an embodiment of the present disclosure. It can be understood that FIG. 4 is merely an embodiment of step S103 described in the context of FIG. 1, and thus the description provided for FIG. 1 also applies to FIG. 4.

As shown in FIG. 4, at step S401, the coarse ranking distillation module outputs coarse ranking scores for the fine ranking of commodities under the training samples. In one implementation scenario, the training samples first are subject to feature extraction through the MLP in the multi-target scoring module, followed by the output of coarse ranking scores for the fine ranking of commodities by the coarse ranking distillation module. At step S402, the coarse ranking scores for the samples are normalized to obtain corresponding normalized coarse ranking scores. In some embodiments, normalization such as through softmax can be used to obtain normalized coarse ranking scores, denoted as softmax(yᵢ), where yᵢ represents the coarse ranking scores.

Further, at step S403, fine ranking scores of the fine ranking model for fine ranking of commodities under the training samples are obtained. Based on the obtained fine ranking scores, at step S404, the maximum and minimum fine ranking scores are determined, and at step S405, the commodity indices corresponding to the maximum and minimum fine ranking scores respectively are identified. For example, the commodity index corresponding to the maximum fine ranking score is k=argmax(zᵢ), and the commodity index corresponding to the minimum fine ranking score is j=argmin(zᵢ), where zᵢ denotes the aforementioned fine ranking scores.

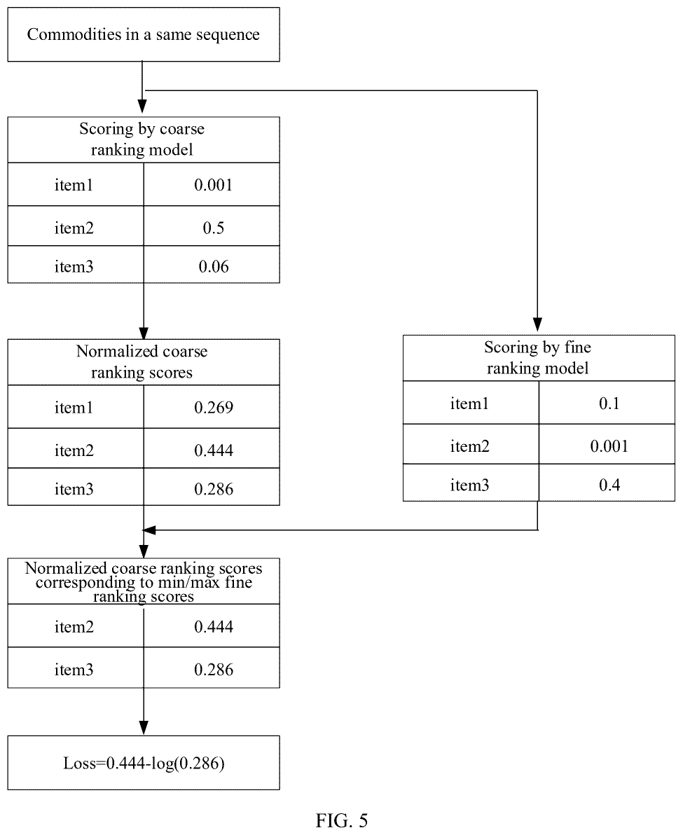

Then, at step S406, based on the commodity indices corresponding to the maximum and minimum fine ranking scores, the normalized coarse ranking scores of the commodities with the maximum and minimum fine ranking scores are determined, denoted as softmax(yᵢ)ₖ and softmax(yᵢ)ⱼ, respectively. Finally, at step S407, the min-max distillation loss is calculated based on the negative logarithm of the normalized coarse ranking score of the commodity with the maximum fine ranking score and the normalized coarse ranking score of the commodity with the minimum fine ranking score. Specifically, in some embodiments of the present disclosure, the mini-max distillation loss can be calculated as shown in formula (1) above. The calculation of the aforementioned min-max distillation loss will be further detailed with a specific example in conjunction with FIG. 5.

FIG. 5 illustrates an exemplary schematic for calculating the min-max distillation loss according to an embodiment of the present disclosure. As shown in FIG. 5, let's assume that a coarse ranking model scores commodities in a same sequence to obtain coarse ranking scores for each commodity. For example, for commodities item1, item2, and item3, their respective coarse ranking scores are 0.001, 0.5, and 0.06. Next, these coarse ranking scores are normalized to obtain corresponding normalized coarse ranking scores. As illustrated, the normalized coarse ranking scores for item1, item2, and item3 are 0.269, 0.444, and 0.286, respectively.

Assuming that a fine ranking model scores the same sequence of commodities, the fine ranking scores for item1, item2, and item3 are 0.1, 0.001, and 0.4, respectively. Based on these fine ranking scores, the maximum fine ranking score of 0.4 and the minimum fine ranking score of 0.001 can be identified, corresponding to commodity indices 3 and 2, respectively. Then, based on the commodity indices corresponding to the maximum and minimum fine ranking scores, the normalized coarse ranking scores for the commodities with the maximum and minimum fine ranking scores are determined. For instance, the normalized coarse ranking score for the commodity with the maximum fine ranking score, item3, is 0.286, and for the commodity with the minimum fine ranking score, item2, it is 0.444. Substituting these into the given formula (1) results in Loss=0.444−log(0.286).

According to embodiments of the present disclosure, the calculation of the min-max distillation loss is simple and efficient, creating a clear distinction between the predicted coarse ranking scores of the commodity with the maximum fine ranking score, the commodity with the minimum fine ranking score, and other commodities. This method helps to prevent issues in recommendation systems where severely imbalanced samples lead to very low fine ranking scores, making it difficult for the coarse ranking model to learn effectively. It also avoids situations where the fine ranking scores are too low to make small differences in fine ranking scores within the same List-Wise sample, which makes it challenging for the coarse ranking model to learn knowledge on the sequential order and differences in scores between different commodities. Consequently, the coarse ranking model can better fit the fine ranking results, enhancing the consistency between coarse and fine ranking scoring.

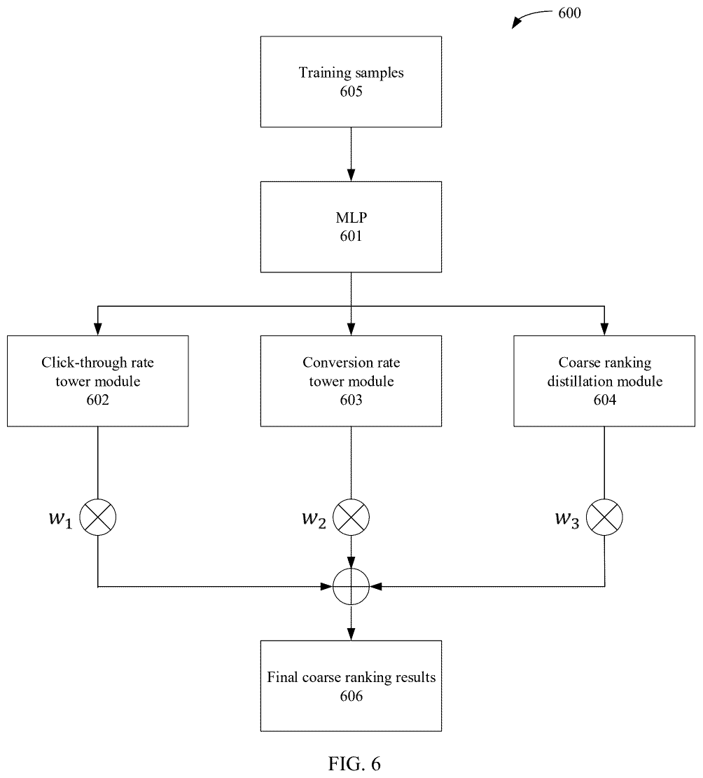

In some embodiments of the present disclosure, fine ranking knowledge is distilled into an independent model target tower (the coarse ranking distillation module in this embodiment) and combined with multi-target scoring results (such as click-through rate and conversion rate) to optimize the coarse ranking scoring model. This approach ensures that the degree of knowledge transferred from the fine ranking model is controllable, as illustrated in FIG. 6.

FIG. 6 displays an exemplary schematic of the overall coarse ranking scoring model 600 according to some embodiments of the present disclosure. As shown in FIG. 6, the coarse ranking scoring model 600 may include a multi-target scoring module (comprising an MLP 601, a click-through rate tower module 602, and a conversion rate tower module 603) and a coarse ranking distillation module 604. In an implementation scenario, by inputting the aforementioned training samples 605 into the coarse ranking scoring model, feature extraction is first performed on the training samples 605 by the MLP 601. The samples then undergo scoring operations for ranking products under click and conversion operations through the click-through rate tower module 602 and the conversion rate tower module 603, respectively, to obtain a click-through rate scoring result and a conversion rate scoring result. Simultaneously, after the MLP 601 extracts features from the training samples 605, the coarse ranking distillation module 604 outputs a predicted coarse ranking result (i.e., coarse ranking scores) for fine ranking of commodities under the training samples.

Further, the final coarse ranking results 606 of the coarse ranking scoring model for commodities coarse ranking are obtained by combining the aforementioned click-through rate scoring result, the conversion rate scoring result, and the predicted coarse ranking result. Specifically, weight coefficients w₁, w₂, w₃ can be set for the click-through rate scoring result, the conversion rate scoring result, and the predicted coarse ranking result, respectively, and the final coarse ranking result 606 can be obtained based on a weighted sum. For instance, assuming the click-through rate scoring result is denoted as o₁, the conversion rate scoring result as o₂, and the predicted coarse ranking result as o₃, the final coarse ranking result for commodity coarse ranking by the coarse ranking scoring model can be obtained based on w₁*o₁+w₂*o₂+w₃*o₃.

It can be understood that the multi-target scoring module already has trained weight parameters loaded into the MLP, the click-through rate tower module, and the conversion rate tower module, i.e., employing incremental learning methods and loading baseline model knowledge. During the training process, only the coarse ranking distillation module is adjusted based on the aforementioned min-max distillation loss, or the impact of the coarse ranking distillation module on the final coarse ranking result can be determined by adjusting the corresponding weight coefficients w₁, w₂, w₃. This facilitates the easy integration of fine ranking model knowledge into the coarse ranking model without significantly affecting the existing coarse ranking knowledge, thus enhancing the accuracy of the coarse ranking scoring model.

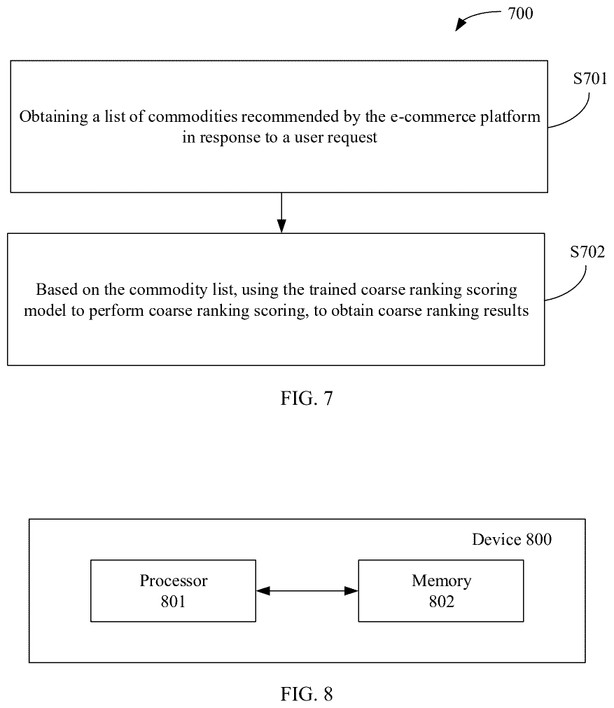

FIG. 7 presents an exemplary flowchart of method 700 for coarse ranking scoring e-commerce commodities according to an embodiment of the present disclosure. As shown in FIG. 7, at step S701, a list of commodities recommended by the e-commerce platform in response to a user request is obtained. At step S702, based on the commodity list, coarse ranking scoring is performed using the trained coarse ranking scoring model to obtain coarse ranking results. That is, by using the trained coarse ranking scoring model on the list of commodities returned in response to a user request, coarse ranking results can be obtained. For more details on the training of the coarse ranking scoring model, refer to the descriptions provided in FIG. 1 through FIG. 6, which will not be reiterated here.

FIG. 8 shows an exemplary structural diagram of a device 800 for training a coarse ranking scoring model for e-commerce commodities according to an embodiment of the present disclosure. As depicted in FIG. 8, the device 800 can include a processor 801 and a memory 802, where the processor 801 communicates with the memory 802 via a bus. The memory 802 stores program instructions for training a coarse ranking scoring model for e-commerce commodities. When these program instructions are executed by the processor 801, they enable the implementation of the method steps described earlier with the figures: generating training samples based on a list of commodities recommended by the e-commerce platform in response to a user request; using a multi-target scoring module based on the training samples to perform scoring operations for commodity ranking under multiple target tasks, thereby obtaining multi-target scoring results; using the coarse ranking distillation module based on the training samples for distillation learning of the fine ranking model's knowledge on fine ranking of commodities, and calculating a min-max distillation loss; and optimizing the final coarse ranking results of the coarse ranking scoring model for commodity coarse ranking based on the multi-target scoring results and the min-max distillation loss, thus training the coarse ranking scoring model for e-commerce commodities.

In some embodiments, the memory 802 may also store program instructions for coarse ranking scoring e-commerce commodities. When these program instructions are executed by the processor 801, they facilitate the implementation of the method steps described earlier with the figures: obtaining a list of commodities recommended by the e-commerce platform in response to a user request; and based on the commodity list, performing coarse ranking scoring using the trained coarse ranking scoring model to obtain coarse ranking results.

Based on the descriptions provided with the figures, those skilled in the art can understand that the embodiments of the present disclosure can also be implemented through software programs. Consequently, the present disclosure further provides a non-transitory machine readable medium. This computer-readable storage medium has stored thereon computer-readable instructions for training a coarse ranking scoring model for e-commerce commodities or for coarse ranking scoring e-commerce commodities. When executed by one or more processors, these computer-readable instructions implement the method described with FIG. 1 for training a coarse ranking scoring model for e-commerce commodities, or the method described with FIG. 7 for coarse ranking scoring e-commerce commodities.

From the descriptions of the embodiments, it is clear to those skilled in the art that the various embodiments can be realized through software in conjunction with necessary general hardware platforms, though they can also be realized through hardware. Based on such understanding, the essential part of the technical solutions or the part that contributes to the existing technology can be embodied in the form of a software product, which can be stored on a computer-readable storage medium, such as ROM/RAM, magnetic disk, optical disk, etc., including several instructions to make a computer device (which can be a personal computer, server, or network device, etc.) execute the methods described in the various embodiments or some parts thereof.

It should be noted that although the actions of the present disclosure's methods are described in a specific order in the figures, this does not imply that these actions must be performed in the specified order, or that all the actions shown must be performed to achieve the desired result. Instead, the steps depicted in the flowcharts can be performed in a different order. Additionally or alternatively, some steps may be omitted, multiple steps can be merged into a single step for execution, and/or a single step can be divided into multiple steps for execution.

Based on the terms provided below, a clearer understanding of the previously discussed content can be achieved:

Term A1, a method for training a coarse ranking scoring model for e-commerce commodities, wherein the coarse ranking scoring model comprises a multi-target scoring module and a coarse ranking distillation module, and the method comprises: generating training samples based on a list of commodities recommended by an e-commerce platform in response to a user request; using the multi-target scoring module, based on the training samples, to perform scoring operations for ranking the commodities under multiple target tasks so as to obtain multi-target scoring results; using the coarse ranking distillation module, based on the training samples, to perform distillation learning from a fine ranking model's scoring knowledge on fine ranking of commodities, and calculate a min-max distillation loss; and optimizing a final coarse ranking result of the coarse ranking scoring model for coarse ranking the commodities according to the multi-target scoring results and the min-max distillation loss, to train the coarse ranking scoring model for e-commerce commodities.

Term A2, the method according to Term A1, wherein said generating training samples based on a list of commodities recommended by an e-commerce platform in response to a user request comprises: determining whether the list of commodities recommended by the e-commerce platform in response to the user request contains commodities under the target task; and constructing a training dataset based on a determination result to generate the training samples.

Term A3, the method according to Term A2, wherein said constructing a training dataset based on a determination result to generate the training samples comprises: constructing first sample data and second sample data based on the determination result; and constructing the training dataset based on the first sample data and the second sample data to generate the training samples.

Term A4, the method according to Term A3, wherein said constructing first sample data and second sample data based on the determination result comprises: in response to the existence of a commodity under the target task in the list of commodities recommended by the e-commerce platform, aggregating fine ranking scores and commodity features of the other commodities except the commodity under the current target task into multiple first list features and adding the first list features to the commodity under the current target task to form the first sample data; and, in response to the absence of a commodity under the target task in the list of commodities recommended by the e-commerce platform, aggregating fine ranking scores and commodity features of the commodities except the commodity with the highest fine ranking score into multiple second list features and adding the second list features to the commodity with the highest fine ranking score to form the second sample data.

Term A5, the method according to any of Terms A1-A4, wherein the target task includes at least a click operation or a conversion operation, and the conversion operation include at least an add-to-cart operation and/or a place-order operation.

Term A6, the method according to Term A5, wherein the multi-target scoring module includes a multilayer perceptron, a click-through rate tower module, and a conversion rate tower module, and said using the multi-target scoring module, based on the training samples, to perform scoring operations for ranking the commodities under multiple target tasks so as to obtain multi-target scoring results comprises: using the multilayer perceptron to extract features from the training samples and performing scoring operations for ranking commodities under click and conversion operations through the click-through rate tower module and the conversion rate tower module, respectively, to obtain a click-through rate scoring result and a conversion rate scoring result.

Term A7, the method according to Term A6, wherein said using the coarse ranking distillation module, based on the training samples, to perform distillation learning from a fine ranking model's scoring knowledge on fine ranking of commodities and calculate a min-max distillation loss comprises: obtaining fine ranking scores of the fine ranking model for commodity fine ranking under the training samples; outputting coarse ranking scores for commodity fine ranking under the training samples using the coarse ranking distillation module and normalizing these coarse ranking scores to obtain normalized coarse ranking scores; and calculating the min-max distillation loss based on the fine ranking scores and the normalized coarse ranking scores.

Term A8, the method according to Term A7, wherein said calculating the min-max distillation loss based on the fine ranking scores and the normalized coarse ranking scores comprises: determining a maximum fine ranking score and a minimum fine ranking scores from the fine ranking scores and identifying the commodity indices corresponding to the maximum fine ranking score and the minimum fine ranking score; determining the normalized coarse ranking scores of the commodities with the maximum fine ranking score and the minimum fine ranking score based on their respective commodity indices; and calculating the min-max distillation loss based on the normalized coarse ranking scores of the commodities with the maximum fine ranking score and the minimum fine ranking score.

Term A9, the method according to Term A8, wherein said calculating the min-max distillation loss based on the normalized coarse ranking scores of the commodities with the maximum fine ranking score and the minimum fine ranking score comprises: calculating the min-max distillation loss by using the negative logarithm of the normalized coarse ranking score of the commodity with the maximum fine ranking score and the normalized coarse ranking score of the commodity with the minimum fine ranking score.

Term A10, the method according to Term A6, wherein said optimizing a final coarse ranking result of the coarse ranking scoring model for coarse ranking the commodities according to the multi-target scoring results and the min-max distillation loss, to train the coarse ranking scoring model for e-commerce commodities comprises: setting weighting coefficients for the click-through rate scoring result, the conversion rate scoring result, and the predicted coarse ranking result output from the coarse ranking distillation module and adjusted based on the min-max distillation loss; and adjusting these corresponding weighting coefficients to optimize the final coarse ranking results of the coarse ranking scoring model, thereby training the coarse ranking scoring model for e-commerce commodities.

Term A11, a device for training a coarse ranking scoring model for e-commerce commodities, comprising: a processor; and a memory having stored thereon computer instructions for training the coarse ranking scoring model for e-commerce commodities that, when executed by the processor, cause implementation of the method described in any one of Terms A1-A10.

Term A12, a method for coarse ranking scoring e-commerce commodities, comprising: obtaining a list of commodities recommended by an e-commerce platform in response to a user request; and using a coarse ranking scoring model, trained according to the method described in any one of Terms A1-A10, to perform coarse ranking scoring based on the list of commodities to obtain coarse ranking results.

Term A13, a device for coarse ranking scoring e-commerce commodities, comprising: a processor; and a memory having stored thereon computer instructions for coarse ranking scoring e-commerce commodities that, when executed by the processor, cause implementation of the method described in Term A12.

Term A14, a non-transitory machine readable medium having stored thereon computer program instructions for training a coarse ranking scoring model for e-commerce commodities, which when executed by one or more processors, cause implementation of the method described in any one of Terms A1-A10, or having stored thereon computer program instructions for coarse ranking scoring e-commerce commodities that, when executed by one or more processors, cause implementation of the method described in Term A12.

It should be understood that terms such as “first”, “second”, “third”, and “fourth” appear in the claims, specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that the terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

While the embodiments of the present disclosure are described above, the content is only for the purpose of facilitating the understanding of the disclosure and is not intended to limit the scope and application scenarios of this disclosure. Any technical person in the prior art described in the present disclosure can make any modifications and variations in the form and details of implementation without departing from the spirit and scope disclosed by the present disclosure, but the patent protection scope of this application is still to be determined by the scope defined by the attached claims.

Additionally, the collection and acquisition of various data in the present disclosure comply with relevant legal regulations and are authorized by the data providers. Any organization or individual that needs to obtain external data should legally obtain authorization and ensure data security. Illegal collection, use, processing, transmission of unauthorized or unprotected data, and the illegal sale, provision, or public disclosure of unauthorized or unprotected data are prohibited.

What is claimed is:

1. A method for training a coarse ranking scoring model for e-commerce commodities, wherein the coarse ranking scoring model comprises a multi-target scoring module and a coarse ranking distillation module, the method comprising:
generating training samples based on a list of commodities recommended by an e-commerce platform in response to a user request;
using the multi-target scoring module, based on the training samples, to perform scoring operations for ranking the commodities under multiple target tasks so as to obtain multi-target scoring results;
using the coarse ranking distillation module, based on the training samples, to perform distillation learning from a fine ranking model's scoring knowledge on fine ranking of commodities, and calculate a min-max distillation loss; and
optimizing a final coarse ranking result of the coarse ranking scoring model for coarse ranking the commodities according to the multi-target scoring results and the min-max distillation loss, to train the coarse ranking scoring model for e-commerce commodities.

2. The method according to claim 1, wherein the generating of the training samples comprises:
determining whether the list of commodities recommended by the e-commerce platform in response to the user request contains commodities under the target task; and
constructing a training dataset based on a determination result to generate the training samples.

3. The method according to claim 2, wherein the constructing of the training dataset comprises:
constructing first sample data and second sample data based on the determination result; and
constructing the training dataset based on the first sample data and the second sample data to generate the training samples.

4. The method according to claim 3, wherein the constructing of the first sample data and second sample data comprises:
in response to the existence of a commodity under the target task in the list of commodities recommended by the e-commerce platform, aggregating fine ranking scores and commodity features of the other commodities except the commodity under the current target task into multiple first list features and adding the first list features to the commodity under the current target task to form the first sample data; and
in response to the absence of a commodity under the target task in the list of commodities recommended by the e-commerce platform, aggregating fine ranking scores and commodity features of the commodities except the commodity with the highest fine ranking score into multiple second list features and adding the second list features to the commodity with the highest fine ranking score to form the second sample data.

5. The method according to claim 1, wherein the target task includes at least a click operation or a conversion operation, and the conversion operation include at least an add-to-cart operation and/or a place-order operation.

6. The method according to claim 5, wherein the multi-target scoring module includes a multilayer perceptron, a click-through rate tower module, and a conversion rate tower module, and
the using of the multi-target scoring module comprises using the multilayer perceptron to extract features from the training samples and performing scoring operations for ranking commodities under click and conversion operations through the click-through rate tower module and the conversion rate tower module, respectively, to obtain a click-through rate scoring result and a conversion rate scoring result.

7. The method according to claim 6, wherein the using of the coarse ranking distillation module comprises:
obtaining fine ranking scores of the fine ranking model for commodity fine ranking under the training samples;
outputting coarse ranking scores for commodity fine ranking under the training samples using the coarse ranking distillation module and normalizing these coarse ranking scores to obtain normalized coarse ranking scores; and
calculating the min-max distillation loss based on the fine ranking scores and the normalized coarse ranking scores.

8. The method according to claim 7, wherein the calculating of the min-max distillation loss comprises:
determining a maximum fine ranking score and a minimum fine ranking scores from the fine ranking scores and identifying the commodity indices corresponding to the maximum fine ranking score and the minimum fine ranking score;
determining the normalized coarse ranking scores of the commodities with the maximum fine ranking score and the minimum fine ranking score based on their respective commodity indices; and
calculating the min-max distillation loss based on the normalized coarse ranking scores of the commodities with the maximum fine ranking score and the minimum fine ranking score.

9. The method according to claim 8, wherein the calculating of the min-max distillation loss comprises:
calculating the min-max distillation loss by using the negative logarithm of the normalized coarse ranking score of the commodity with the maximum fine ranking score and the normalized coarse ranking score of the commodity with the minimum fine ranking score.

10. The method according to claim 6, wherein the optimizing of the final coarse ranking result comprises:
setting weighting coefficients for the click-through rate scoring result, the conversion rate scoring result, and the predicted coarse ranking result output from the coarse ranking distillation module and adjusted based on the min-max distillation loss; and
adjusting these corresponding weighting coefficients to optimize the final coarse ranking results of the coarse ranking scoring model, thereby training the coarse ranking scoring model for e-commerce commodities.

11. A device for training a coarse ranking scoring model for e-commerce commodities, the device comprising:
a processor; and
a memory having stored thereon computer instructions for training the coarse ranking scoring model for e-commerce commodities that, when executed by the processor, cause implementation of:
generating training samples based on a list of commodities recommended by an e-commerce platform in response to a user request;
using a multi-target scoring module within the coarse ranking scoring model, based on the training samples, to perform scoring operations for ranking the commodities under multiple target tasks so as to obtain multi-target scoring results;
using a coarse ranking distillation module within the coarse ranking scoring model, based on the training samples, to perform distillation learning from a fine ranking model's scoring knowledge on fine ranking of commodities, and calculate a min-max distillation loss; and
optimizing a final coarse ranking result of the coarse ranking scoring model for coarse ranking the commodities according to the multi-target scoring results and the min-max distillation loss, to train the coarse ranking scoring model for e-commerce commodities.

12. The device according to claim 11, wherein the computer instructions are further executed to cause implementation of:
determining whether the list of commodities recommended by the e-commerce platform in response to the user request contains commodities under the target task;
constructing first sample data and second sample data based on the determination result; and
constructing the training dataset based on the first sample data and the second sample data to generate the training samples.

13. The device according to claim 12, wherein the computer instructions are further executed to cause implementation of:
in response to the existence of a commodity under the target task in the list of commodities recommended by the e-commerce platform, aggregating fine ranking scores and commodity features of the other commodities except the commodity under the current target task into multiple first list features and adding the first list features to the commodity under the current target task to form the first sample data; and
in response to the absence of a commodity under the target task in the list of commodities recommended by the e-commerce platform, aggregating fine ranking scores and commodity features of the commodities except the commodity with the highest fine ranking score into multiple second list features and adding the second list features to the commodity with the highest fine ranking score to form the second sample data.

14. The device according to claim 1, wherein the target task includes at least a click operation or a conversion operation, and the conversion operation include at least an add-to-cart operation and/or a place-order operation, and the multi-target scoring module includes a multilayer perceptron, a click-through rate tower module, and a conversion rate tower module, and
the computer instructions are further executed to cause implementation of:
using the multilayer perceptron to extract features from the training samples and performing scoring operations for ranking commodities under click and conversion operations through the click-through rate tower module and the conversion rate tower module, respectively, to obtain a click-through rate scoring result and a conversion rate scoring result.

15. The device according to claim 14, wherein the computer instructions are further executed to cause implementation of:
obtaining fine ranking scores of the fine ranking model for commodity fine ranking under the training samples;
outputting coarse ranking scores for commodity fine ranking under the training samples using the coarse ranking distillation module and normalizing these coarse ranking scores to obtain normalized coarse ranking scores; and
calculating the min-max distillation loss based on the fine ranking scores and the normalized coarse ranking scores.

16. The device according to claim 15, wherein the computer instructions are further executed to cause implementation of:
determining a maximum fine ranking score and a minimum fine ranking scores from the fine ranking scores and identifying the commodity indices corresponding to the maximum fine ranking score and the minimum fine ranking score;
determining the normalized coarse ranking scores of the commodities with the maximum fine ranking score and the minimum fine ranking score based on their respective commodity indices; and
calculating the min-max distillation loss based on the normalized coarse ranking scores of the commodities with the maximum fine ranking score and the minimum fine ranking score.

17. The device according to claim 14, wherein the computer instructions are further executed to cause implementation of:
setting weighting coefficients for the click-through rate scoring result, the conversion rate scoring result, and the predicted coarse ranking result output from the coarse ranking distillation module and adjusted based on the min-max distillation loss; and
adjusting these corresponding weighting coefficients to optimize the final coarse ranking results of the coarse ranking scoring model, thereby training the coarse ranking scoring model for e-commerce commodities.

18. A non-transitory machine readable medium having stored thereon computer program instructions for training a coarse ranking scoring model for e-commerce commodities, which when executed by one or more processors, cause implementation of:
generating training samples based on a list of commodities recommended by an e-commerce platform in response to a user request;
using a multi-target scoring module within the coarse ranking scoring model, based on the training samples, to perform scoring operations for ranking the commodities under multiple target tasks so as to obtain multi-target scoring results;
using a coarse ranking distillation module within the coarse ranking scoring model, based on the training samples, to perform distillation learning from a fine ranking model's scoring knowledge on fine ranking of commodities, and calculate a min-max distillation loss; and
optimizing a final coarse ranking result of the coarse ranking scoring model for coarse ranking the commodities according to the multi-target scoring results and the min-max distillation loss, to train the coarse ranking scoring model for e-commerce commodities.

19. A method for coarse ranking scoring e-commerce commodities, the method comprising:
obtaining a list of commodities recommended by an e-commerce platform in response to a user request; and
using a coarse ranking scoring model, trained according to the method described in claim 1, to perform coarse ranking scoring based on the list of commodities to obtain coarse ranking results.

20. A device for coarse ranking scoring e-commerce commodities, the device comprising:
a processor; and
a memory having stored thereon computer instructions for coarse ranking scoring e-commerce commodities that, when executed by the processor, cause implementation of the method described in claim 19.
